(19) United States
(12) Patent Application Publication
(10) Pub. No.: US 2021/0312224 A1
(43) Pub. Date: Oct. 7, 2021

(54) SYSTEM AND METHOD FOR CREATING PER-CUSTOMER MACHINE VISION PERSONAS BASED ON MOBILE NETWORK METADATA

(71) Applicant: GOLDENSPEAR LLC, San Francisco, CA (US)

(72) Inventors: Javier Castan, Barcelona (ES); Santos Moises Soto, San Francisco, CA (US); Anuradha Sridhar, Plano, TX (US); Mike Logan, Overland Park, KS (US); Jordi Muria Portillo, Barcelona (ES)

(73) Assignee: GOLDENSPEAR LLC, San Francisco, CA (US)

(21) Appl. No.: 17/220,527

(22) Filed: Apr. 1, 2021

Related U.S. Application Data
(60) Provisional application No. 63/004,208, filed on Apr. 2, 2020.
(60) Provisional application No. 63/005,035, filed on Apr. 3, 2020.
(60) Provisional application No. 63/007,819, filed on Apr. 9, 2020.

(51) Int. Cl. G06K 9/62; H04W 8/02; H04W 8/18; G06T 1/00; G06K 9/00

(52) U.S. Cl. CPC G06K 9/629; H04W 8/02; H04W 8/18; G06K 2209/27; G06K 9/00785; G06K 9/00281; G06T 1/0014

(57) ABSTRACT

A system is disclosed that includes a video camera, a local image processing computer, a remote event detection server, and a remote data integration database. This technology utilizes deep learning and domain-specific customer personas to rapidly derive economically useful insights from real-time video imagery with an emphasis on personal fashion and lifestyle.

### PRIORITY CLAIM

The present application claims priority to U.S. Provisional Patent Application No. 63/004,208, filed on Apr. 2, 2020, entitled “SYSTEM AND METHOD FOR CREATING PER-CUSTOMER MACHINE VISION PERSONAS BASED ON MOBILE NETWORK METADATA,” U.S. Provisional Patent Application No. 63/005,035, filed on Apr. 3, 2020, entitled “SYSTEM AND METHOD FOR CREATING PER-CUSTOMER MACHINE VISION PERSONAS BASED ON MOBILE NETWORK METADATA,” and U.S. Provisional Patent Application No. 63/007,819, filed on Apr. 9, 2020, entitled “SYSTEM AND METHOD FOR CREATING PER-CUSTOMER MACHINE VISION PERSONAS BASED ON MOBILE NETWORK METADATA,” which applications are incorporated by reference herein in their entirety.

### BACKGROUND

With the emergence of eCommerce, global retailers are in a race to modernize the shopping experience. Historically on-line firms seek to play to their advantages, which include selection, convenience, and web-based analytics to overcome perceived weaknesses such as the high volume of returns, extreme comparison shopping, high-tech fraud, and the propensity of many customers to abandon purchases in the final stages. Similarly, historically store-based retailers seek to exploit their advantages of immediate gratification, merchandise interaction, and human relationships to counter eCommerce sales erosion, infrastructure costs, and inventory loss. Both are rapidly moving to integrate the best aspects of on-line and in-store shopping and over time these models will continue to converge, influenced by additional forces such as the rise of 5G networks and shifting population demographics. Tools that help integrate the on-line and in-store shopping experience will be central to realizing this transition.

Fueled by large on-line retailers like Amazon, retail analytics has become a significant global market segment, valued at $3 Billion in 2018 and expected to grow to over $8 billion by 2024. Typical products in the space might include chat bots for customer care, application of machine learning to Customer Relationship Management (CRM) data, machine vision for fraud prevention, and predictive just-in-time ordering to minimize inventory carrying costs. Within retail stores, machine vision might also be used to count total visitors, estimate “conversions”—sales to those customers—and predict interests based on an individual's movements within the store. The trajectory of individual customers through a store can be modeled through application of Kalman filtering, possibly aided by wireless inputs such as WiFi or BlueTooth.

Fusion of in-store data has been disrupted by rapid evolution of technology in this space. Additional security features on modern wireless handsets such as randomized MAC addresses has limited their value as a unique proxy for customer identity and the availability of higher-resolution cameras had enabled much more detailed but computationally intensive extraction of demographic detail. The rise of 5G technology with associated IoT protocols such as Zigbee promise more disruptions in the immediate future, with significant new opportunities being opened up for vertical (i.e., market-specific) integration between wireless operators and traditional retail solutions.

### DESCRIPTION OF THE DRAWINGS

FIG. 1 illustrates a representative environment in which the present technology may be implemented.

FIG. 2 is a plot of feature vectors, dimensionally reduced to 2D space.

FIG. 3 is a grouping of 2D feature vector representation to form personas.

FIG. 4 is a schematic representation of a wireless sensor.

FIG. 5 is a plot of feature vectors gated by a particular UE identifier.

FIG. 6 is a plot of feature vectors gated by a particular UE identifier and accumulated over distinct time periods.

FIG. 7 is a plot showing identification of a single UE owner from highly similar profiles.

FIG. 8 is a schematic block diagram illustrating an exemplary implementation of retail sensor.

FIG. 9 is sample format for a UE update record.

FIG. 10 is a schematic block diagram of implemented solution with a virtual subscriber database partitioned for Facial IDs derived from in-store video analysis, Device IDs derived from cellular metadata, and Matched Profiles combining both.

FIG. 11 is a flowchart showing handling of cellular proximity events.

FIG. 12 is a flowchart showing handling of imagery-based detection events.

FIG. 13 is a flowchart showing creation of UE-based personas.

### DETAILED DESCRIPTION

The present technology will now be described with reference to the figures, which in general relate to the generation of personal trait feature vectors using cameras or other sensors to sense physical attributes of one or more people. The feature vectors may then be analyzed using artificial intelligence algorithms to both define persona groups within which different feature vectors fit, and how well a given feature vector fits within a given persona group. This present technology enables the association of imagery-derived demographic information to a common individual to augment their purchasing history and understand their evolution of stylistic preferences over time.

This patent disclosure details an event-based marketing solution that leverages metadata available on modern 4G/5G cellular data networks to identify “visits” from repeat customers and enrich them with demographic details derived from video imagery analyzed in real-time using edge computing resources deployed remotely in the venue. This data can be used to understand visitor stylistic preferences, shopping patterns, and likely purchasing intentions which can in turn be utilized in the store to assist sales representatives and on-line to ensure the brand is offering the merchandise most desired by their most loyal customer base. Local image processing is intended to align with emerging consumer privacy regulations and control distribution of sensitive imagery, while also giving the customer the ability to review, edit and delete information as they see fit.

Advanced machine vision (MV) and image processing are central to this technology as they allow for isolation and extraction of key demographic features as well as on-going subject tracking despite occlusions and intermittent background interference. U.S. Provisional Patent Application No. 62/979,959, entitled “Machine Learning for Rapid Analysis of Image Data via Curated Customer Personas, filed Feb. 21, 2020 (“the '959 Application”) (incorporated by reference herein in its entirety), discloses feature vectors developed for each visitor that can then be analyzed in near real-time by mapping them to a family of vector templates referred to as “personas” which are tied to niche market segments, on-line style influencers, and key purchasing groups specific to the fashion and lifestyle market segments. The personas themselves are tied to specific inventory mix, historical revenue targets, and related business operation information, with customers generally mapped to multiple personas to increase diversity of product recommendations. The end result is to enable all sales staff to act as a brand ambassador at the highest level, with recommendation for their customers that are engaging, trendy, and revenue-maximizing for the retail operator.

Per the technology of this present disclosure, the mapping of customers to personas can become much more precise in the presence of accompanying signaling metadata from modern wireless data networks such as Wi-Fi, LTE, and 5G. A visitor's cell phone provides a reliable proxy indicating their presence, even if not tied directly to Personally Identifying Information (PII) such as phone number or email address. The 4G/5G signaling events of interest are generated as part of normal network operations carrying data traffic, especially when consumer devices transition between coverage modes such as from the macro radio network to a 4G or 5G “small cell” with a relatively constrained coverage area. The solution disclosed here relies on the conversion of these signaling events to external notifications via a SCEF (Service Capability Exposure Function) node or similar implementation intended for this purpose and may be dedicated or segregated by retail-enterprise per a practice referred to as 5G network slicing. WiFi-based detection events can fulfill a similar role in simplifying visual feature vector association process, though with some loss of detection fidelity and consistency. Macro network reports can also be used with a high degree of success, as long as supplemental location data with an error estimate is also provided to suggest the user is within the area of interest.

After as few as one or two visits, the algorithm assigning visitor to representative personas can almost invariably assign a “persona of one” that ties the individual—identified by parametric facial model or “Face ID”—to their cell phone metadata, along with a series of fashion models that reflect how their fashion expression has changed over time. With opt-in, this persona can be further enriched with information from the customers retention account, such as purchase history, loyalty discounts, and accumulated blockchain tokens. Identification of significant changes in this ephemeral alignment of account metadata can also be a highly accurate indicator of potential fraud.

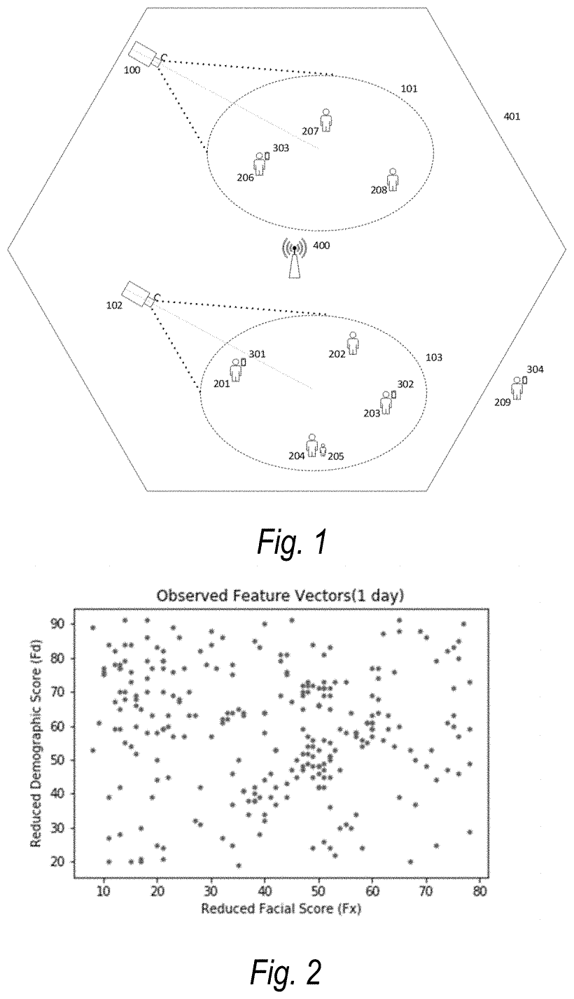

Consider a representative retail environment, as shown in FIG. 1. Multiple visitors—identified as 201-209 in the diagram—are present in the store 401 which is equipped with one or more video security cameras. Two cameras are shown—items 101 and 102—but any number of cameras could be deployed to fulfill on the objective of having close to 100% coverage of the space with minimal overlap of camera views. The environment also includes one or more wireless data network devices 400, such as an LTE femto cell, LTE macro cell, 5G femto cell, or WiFi router. A single device 400 is shown in FIG. 1 but multiple devices could be expected for many retail applications. The primary purpose of these wireless devices is extending high-speed mobile data services into the confines of the store. Note that in general all visitors of interest are assumed observed at all times in the retail environment. Wireless data coverage, however, could extend at times to individuals passing outside the store. This is reflected by Person 209 in the diagram. In embodiments the area indicated by element 401 may be store. However, in further embodiments, the area 401 may be a larger geographic area, such as a portion of a town, a town, city, etc.

Also assume that this retail environment is equipped with a retail video analytics solution as disclosed in the '959 application. That is, as guests enter and leave the covered area their imagery is captured on video, the video is sampled to produce the best representative still images, and these images are subjected to deep learning algorithms to develop a vector of information F_{ya} related to each visitor's facial features, demographic attributes, and expressed fashion aesthetic. In embodiments, these feature vectors have high dimensionality (>300 elements), but can readily be subjected to dimension-reducing weighted scoring techniques to obtain a smaller number of aggregated parameters. By generalizing all facial parameters into one weighted score, and by compressing other demographic detail into a second weighted score, then the results of this machine vision application can be plotted, as shown in FIG. 2. Note that this plot shows representative feature vectors for guests over the course of a representative business day. While subject to noise, missing data, and mischaracterization, individuals of similar appearance will tend to cluster in certain areas of this 2-dimensional feature space.

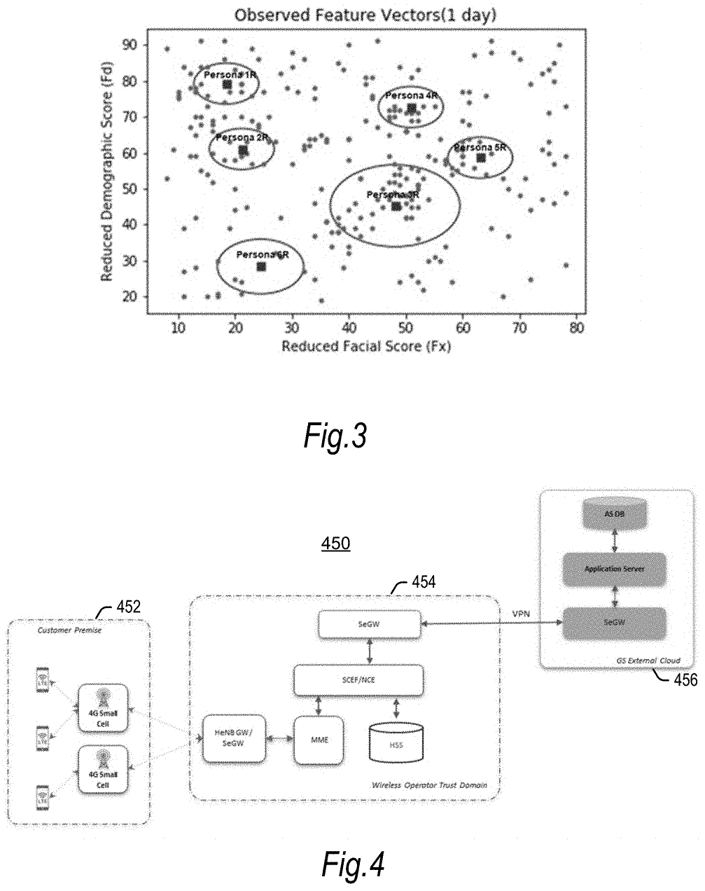

Valuable insights can be derived in a computationally efficient manner by subjecting this feature vector data to persona-based analysis, as summarized in FIG. 3. A “persona” in the marketing context was first coined by Alan Cooper and can be described as a fictional character defined in substantive detail to assist with the holistic design of a product or service encompassing multiple domains of human concern. A conventional application of user personas might be in software product development, where the framing of the multiple concerns representative of a typical user has been shown to greatly improve the usability of resulting products. In the context of machine vison and fashion retailing, these personas provide a convenient model to identify key customer groups, refine niche market segments, and gauge the up-take of certain fashion trends among patrons of a specific store. FIG. 3 shows six representative personas, and each customer will be assigned relative affinity score for each persona group. Each customer will be tied to multiple personas with varying weight and these personas are in turn tied to products and services that will likely appeal to them. This allows each on-floor sales associate to make maximally-effective product suggests based on a current knowledge of stylistic trends and the full line of store product offerings. More detail in this model along with an exemplary implementation can be found in the '959 application.

Several points specific to FIG. 3 that are central to this present disclosure:

1. The number of personas defined is arbitrary. Indeed, per the '959 application, this base is actively curated to minimize error between the observed customer base and persona-based representation.

2. The personas themselves represent economically significant groups of customers specific to the fashion and lifestyle market categories. Smaller groups are usually more accurate, but also less economically significant.

3. The number and shape of personas is expected to shift over time.

4. Each person by design is associated with multiple personas with varying weight.

In some cases, though, it is beneficial to extend this persona concept down to single individuals. This allows, for example, for the association of loyalty account information to that persona along with purchase history. Any specific needs and interests can be readily communicated to sales staff through such a persona, and anomalies can be flagged as potential indicators of fraud. This introduction of a reliable “persona of one” is a focus of this present disclosure.

Consider the novel implementation of a wireless retail sensor 450 as shown in FIG. 4. In this instance, the 4G small cells 452 identified to the left of the diagram represent the units deployed in retail establishment, such as item 400 in FIG. 1. These small cells, in turn, are linked via the Internet to a carrier Enhanced Packet Core (ePC) 454 intended to provide commercial wireless services, as illustrated in the center of the diagram. In the case of an LTE sensor, these small cells will generally tunnel through the public Internet to a Security Gateway within the trust domain of the wireless carrier, with attachments and detachments to the small cell managed by the Mobility Management Entity (MME) operated by the carrier. While the carrier network otherwise operates as normal, select relevant signaling metadata can also be shared by means of an enhanced services gateway, which may be referred to as a Service Capability Exposure Function (SCEF) or a Network Capability Exposure (NCE). The purpose of this network element is to enable enhanced services in 4G or 5G environments, making use of network information such as signaling and profile data, including extension to trusted 3^{rd} party Application Servers (AS) 456. A secure extension from the SCEF/NCE to such an AS responsible for retail presence detection and persona management is shown to the right of the figure.

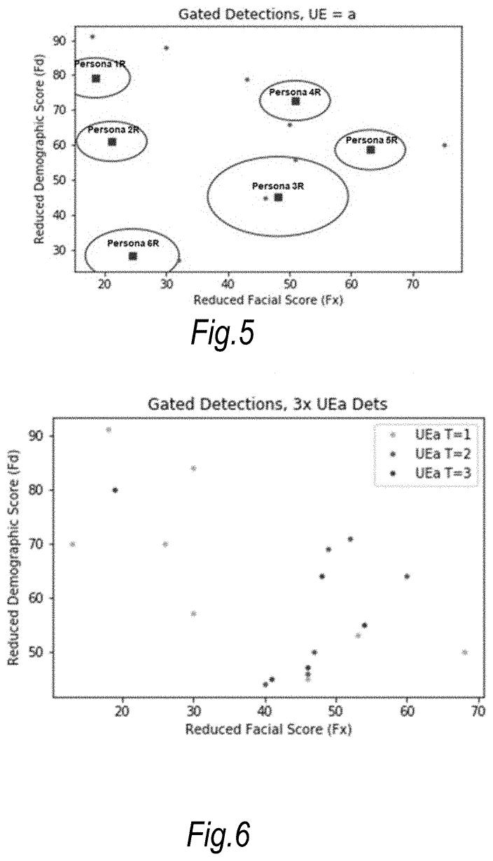

The information exchanged between the SCEF/NCE and the external AS can vary, but at least would include a unique identifier for each UE detected, an identifier for the small cell involved, and a timestamp indicating when the device was detected. In addition, certain carriers might allow for the exchange of a token that would enable limited 2-way interaction with the customer via their UE, limited to the coverage area of specific small cells and potentially requiring a customer opt-in. Related enrichments might also be available from the carrier such as current customer service subscriptions, geolocation of the device within the coverage umbrella of approved cells, and relevant device capabilities. Detection events may incur some lag before being relayed to the AS, as this presence-signaling mechanism is intended to have very low system impact compared to other location-sensing approaches. However, it is assumed that any latency is short relative the dwell time of a customer within a given store, and the event itself is correctly time stamped to the actual time of arrival or departure. Any personally-identifying telecom information such as phone number would be hashed in the manner consistent with U.S. patent application Ser. No. 16/677,244, entitled “System and Method for Enriching Consumer Management Records Using Hashed Mobile Signaling Data,” filed Nov. 7, 2019 (“the '244 Application”), which application is incorporated by reference herein in its entirety. Per this disclosure, the feature vector F_{ya} assigned to each customer observed in a given venue will be automatically enriched with the identifying information of all User Equipment (UE) detected in the store at that time. Given the dwell time of a given customer would nominally be in the range of minutes to tens of minutes, the number of vectors enriched with a particular UE ID can be expected to be much smaller than the universe of all vectors created over a relevant business interval, as illustrated in FIG. 5. In this example, only feature vectors enriched with UE=a are shown, constituting only 5% of the vectors measured over the course for the entire day. This subset, then, represents potential owners of UEa and can be considered an example of Detection Gating. This subset of subscribers can be used, then, to define a new machine-curated persona specific to the device UEa. This persona would initially encompass demographics of all the potential owners of the device.

Intuitively, this persona associated with UEa will have limited value at identifying a single individual based on a single visit. Indeed, an arbitrary number of vectors might have been clustered into its initial formulation and potentially with very contrasting demographics scores based on machine-vision based analysis. Further, some UE detections might be spurious and not related to anyone in the store at all. Because of this, feature vectors will be carried forward individually and not combined or aggregated until additional filtering can be accomplished to identify vectors showing a significant level of intrinsic alignment. The persona for UEa, then, rather than featuring a blended mix of all the relevant feature vectors, will instead be comprised of a cluster of potentially-related feature vectors pending further data to reveal the “real” owner of UEa.

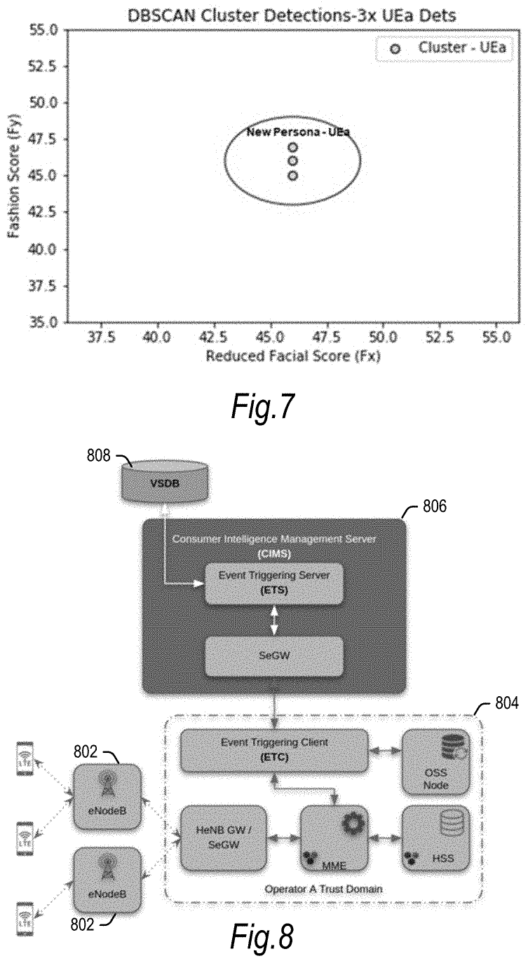

Per the present technology, the residual ambiguity regarding the likely owner of UEa can be resolved rapidly based on subsequent visits, with probability of reliable identification only increasing over time based on additional data points. FIG. 6 shows the situation where UEa has been detected over three separate occasions spaced widely enough in time to be reliably associated with distinct store visits. Assuming an accurate feature vector was obtained with each visit, then these data points will be strongly correlated compared to feature vectors associated with non-owners. With the application of the appropriate unsupervised learning algorithm, the sequence of highly similar profiles can be reliably identified as the owner of UEa, as shown in FIG. 7. In this case Density-Based Spatial Clustering (DBSCAN) was used to identify tight clusters of feature vectors in an automated fashion.

On subsequent visits, the customer associated to Persona UEa will be reliably assigned to this persona as well as to other potentially relevant personas, consistent with this innovative persona-based marketing solution. Further, this association can be manually verified at the checkout stand by a sales associate or via high-res imagery at a self-service kiosk, enabling linking to the appropriate loyalty account with appropriate opt-in. Purchase history, browsing history, and similar information can then be utilized to further enhance fashion and lifestyle recommendations. Further, per the disclosure in the '959 application, each detection event will include a summary of specific fashion items that the customer has worn on previous visits. This can provide information specific to the evolution of a visitor's style, habits and preferences without resorting to disruptive style quizzes or costly-ship-and-return schemes.

Exemplary Implementation

An exemplary implementation of this solution utilizing an LTE femto cell deployment as shown in FIG. 8. The wireless data units 802 deployed in the retail coverage area are shown to the left of the figure, labeled as “eNodeB” LTE Radio Access network elements. These eNodeB elements are connected to the carrier core 804 via a secure tunnel traversing the Public Internet and managed by a carrier-operated instance of an Enhanced Packet Core (ePC). Idle-mode events such as individual UE attach requests are Tracking Area Updates are managed by the carrier MME. These events result in the generation of Event Detail Records (EDRs) in near real-time as well as lower-level Operational Measurements (OMs) used for ongoing management and optimization of the carrier network. The eNodeB's are assigned to a unique Tracking Area to maximize the likelihood that any rove-in events will be detected. These event records can then be pulled periodically via a network element referred to as an Event-Triggering Client (ETC).

The MME in this exemplary implementation generates a trigger record for each of the following events per subscriber:
Traffic Area Update (TAU)—both cell reselection and periodic
LTE Attach
Cancel Location from HSS
LTE Detach

In response to reach detected event, the MME sends the following parameters to ETC for each subscriber:
“attachType” set to “attach”, “reselection”, “periodic”, “cancel”, or “detach”
“imsi” set IMSI
“msisdn” set MSISDN
“imei” set to IMEI
“ecgi” set ECGI
“plmnId” set to PLMNID
“timeStamp” set to current timeStamp

It is the function of the ETC to perform secure hashing of the carrier event data and also to provide an Application Programming Interface (API) allowing trusted Application Servers to subscribe to network event updates for approved eNodeBs.

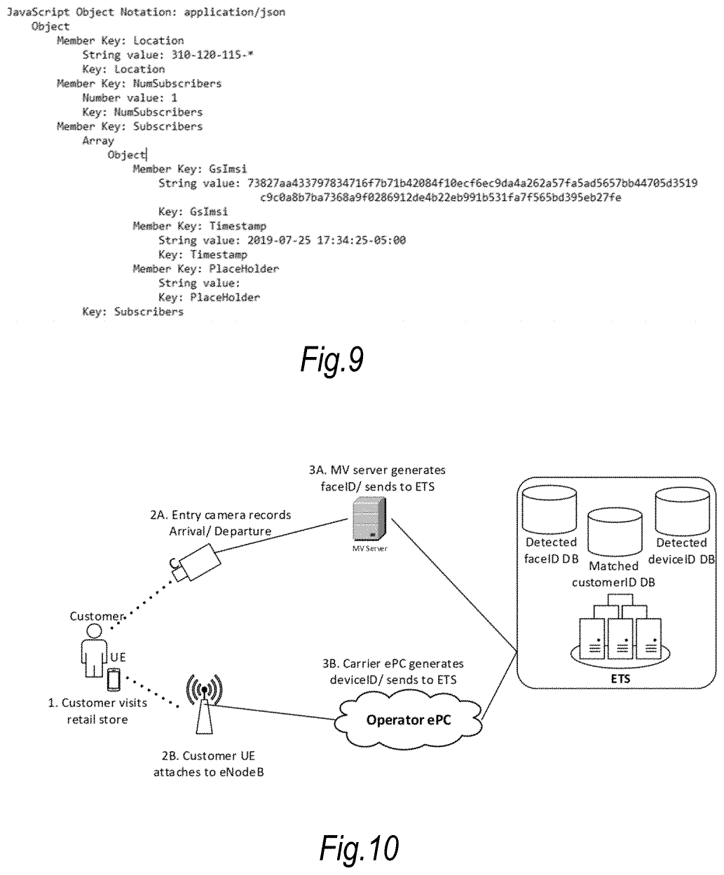

An individual UE update for this exemplary solution is shown in FIG. 9. In this example, the location of the eNodeB is shown in the key-value pairs for “Location.” The Mobile Country Code (MCC), Mobile Network Code (MNC), and Tracking Area fields are shown, with the individual cell ID typically masked for security. Given that this eNodeB is deployed at a precisely registered geographic location within a store, the relative proximity of individual UE's can be accurately inferred. The identity tag for the specific UE is represented by a SHA-256 character sequence, consistent with the details shared in the '244 application. The timestamp key-pair reflects the time when this update was detected by the LTE network. A second timestamp would detail when the message was actually sent by the ETC, as transmission is assumed to be somewhat delayed. A series of these messages would affirm the continued presence of the UE in the coverage area of the eNodeB femtocell. When updates cease, then it can be inferred that the UE has transitioned to a different Tracking Area. Note that many UE “visits” will have an incomplete record of messaging, but presence can be reliably inferred based on a single detection event.

In this implementation, sensor-generated events are aggregated at a cloud network element referred to as the Event Triggering Server (ETS) 806. These events are then stored in a Virtual Subscriber Data Base (VSDB) 808 which also includes the feature vectors derived from on-site video analysis. This is illustrated in FIG. 10, where the structure of the VSDB is expanded to reflect three distinct sets of data:
Detected Face ID Database: Holds data posted after processing instore video stream. Each record contains customer Face ID, Timestamp, Activities reported by different instore cameras;
Detected Device ID Database: Holds data posted by cellular network triggered by device presence instore reported by 4G/5G femtocell. Record contains device hashed IMSI, MSISDN, IMEI;
Matched CustomerID Database: Holds the complete persona per customer. Record contains customer Face ID matched to wireless Device ID, activities, etc.

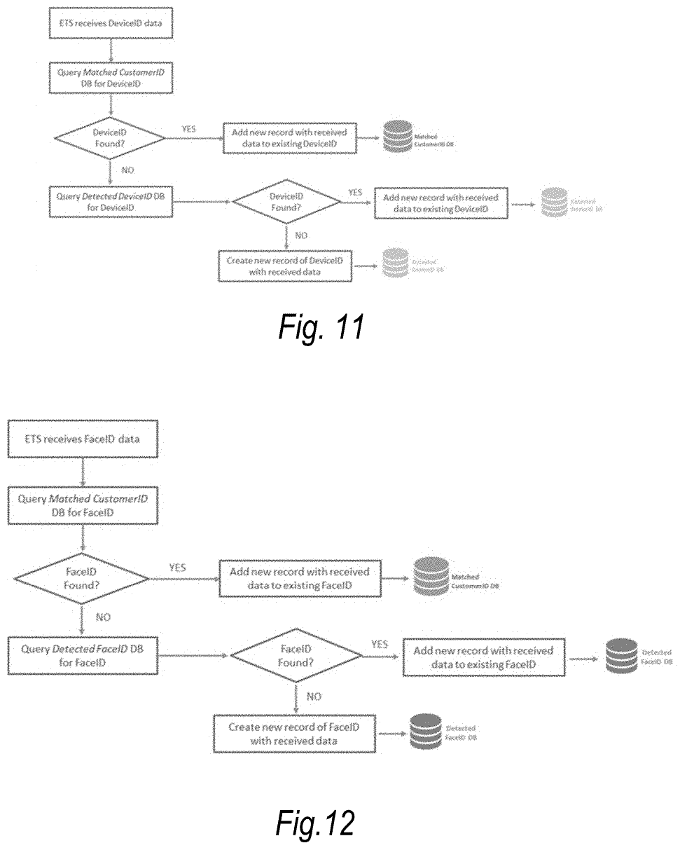

In general, the role of the ETS in this disclosure is to compare in near real-time the stream of UE detection events to the database of machine vision-derived feature vectors in an attempt to create “merged” database entries that can form the basis for UE-confirmed personas specific to an individual or small group. The handling of cellular events by the ETS is illustrated in FIG. 11, while the handling of imagery-based events is illustrated in FIG. 12.

Per FIG. 11, the initial priority is to determine whether the Device ID recently detected has already been matched to a customer record to create a Customer ID. If so, then the record of this visit will be appended to the UE-confirmed persona already defined. If no matched Customer ID is found, then the ETS will next query the Device ID database for any previous unmatched detections. If yes, then this detection event will be added to the record for later use in potentially defining a new UE-Confirmed persona. If no previous match is found, then a new Device ID record will be created. This record ID will be appended to the Face ID records generated during the same time period and will then be available to serve as the basis for future UE-confirmed personas.

Receipt of a new Face ID will result in a similar processing at the ETS. The system will first attempt to confirm whether the Face ID matches closely with any of the existing customerID profiles. For close alignments, the system will queue up this identification for imminent confirmation by the sensor. Once received the marketing system disclosed here can proceed with a high degree of confidence that the visitor has been identified. Assuming no confirmed match with the customerID database the ETS will next search the database of all Face IDs searching for a likely match. If successful this detection event will be linked to the same Face ID record with a weighting based on measured alignment, with multiple possible associations possible. If no similarly-aligned Face ID is detected then a new Face ID is created to await further enrichment.

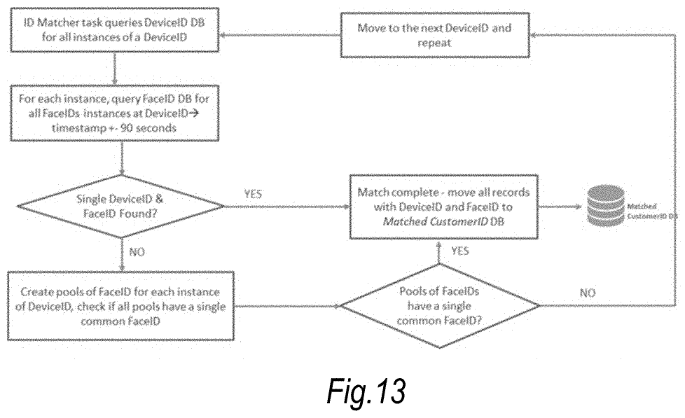

The procedure to create UE-based personas is summarized in FIG. 13. This real-time gating process fetches all instances of detection for a give UE and then searches for a statistically reliable vector that would suggest a common individual present during all detection events. This process is also illustrated in FIG. 7, with the actual demographic comparison accomplished by application of unsupervised machine learning algorithm referred to as Density-Based Spatial Clustering for Applications with Noise (DBSCAN). Note that in practice this procedure is applied at a higher level of dimensionality to maximize the resolution of distinction between profiles. Cosine distance is applied in the current exemplary implementation to simplify comparisons at lower levels of fidelity. The result is the identification of the feature vectors almost certainly associated with the UE under evaluation.

The process of aligning timestamps between Device IDs and Face IDs is a challenging aspect of this exemplary disclosure, given that some detection events can be missed for various technical reasons, and busy store environments can create ambiguity regarding the arrival and departure times of a given visitor given the relatively light focus on precise in-store stacking in this exemplary implementation. Given the relative sensitivity associated with tying a UE-gated Persona to a given individual, a very low threshold of uncertainty is allowed before the detection alignment is rejected. In this situation, subsequent visits may be required to finally establish the firm association between a given customer, their visual characteristics, and the more personally identifying information in their loyalty account.

In one aspect of this invention, no PII data is stored as part of the persona-based marketing solution itself. This connection can be readily established between the UE-based persona and other customer data stored in a conventional Customer Relationship Management system.

In another aspect, even a customer is a UE-linked persona will still benefit from the other aspects of this solution, such as fashion suggestions emulating certain fashion icons, or popular outfits being worn by others to social events.

In another aspect, specific fashion information related to each visit will be maintained within the UE-confirmed persona, including in some cases specific items the visitor was wearing. The ability to understand and build on to evolution of a given visitor's fashion aesthetic over time is a unique aspect of this solution.

In another aspect, the separation of UE from individual owner is will cause a disruption in the system. While this type disruption can certainly be related to predictable events such as a phone upgrade or shared usage of a given device, this information can also be exploited to highlight potential fraud. A common use case would be the absence of a given Face ID for a specific custom that tries to access a specific loyalty account, or use a credit card that has been used in a past by a customer with a known Face ID. These purchases can be discretely denied or another form of payment requested.

In another aspect, the data being collected by this persona-based marketing system is directly controlled by the retailer, as opposed to data purchased from over-the-top app providers such as Google. This allows for the retailers to extend to their customers the courtesy of reviewing, editing, or deleting the data in their profile that they find objectionable.

In another aspect, some UE-linked personas might exhibit ongoing noise or other symptoms of poor data alignment. This might be an indicator of an errant association or other special cause such as individuals that consistently visit in groups or individuals that take deliberate steps to dramatically change their appearance from time to time. For this reason, “noisy” personas may be kept in isolation from other enrichment data, but could still serve as valuable indicators of special factors bearing on the success of a given retail operation.

In another aspect, the Device ID database itself can serve as a valuable source of economically valuable data, including estimating total traffic through a store, dwell time per customer, anonymized location, and approximate quadrant most frequented by the customer during their visit. Effectiveness of marketing campaigns can be measured in part by the impact on foot traffic into the store and net increase in dwell time. If supported by the carrier, two-way messages can be shared with the customer regarding sales, personalized discounts, and similar proximity relevant benefits.

In another aspect, one or a plurality of macro coverage cell sites can provide functionality analogous to one or a plurality of store-based femtocells. In this realization, anonymized location is expected from the carrier to refine the position of the device within the envelope of the macrocell, along with a parameter indicating the relative accuracy of that positioning data. On public networks it is expected that the resolution of location data will be algorithmically adjusted by the carrier such that many end-devices are contained within the reporting error ellipse of any given device. This concept of Elastic Density-Based Reporting (EDBR) is intended to protect consumer privacy by ensuring the location of a given subscriber is co-mingled with at least x other subscribers to prevent direction attribution and may be tunable based on multiple parameters such as observed subscriber density, cell site ID, time-of-day, etc. Devices outside the retail target area or potentially at prolonged rest should be phased out of EDBR reporting data to mitigate reporting on users that may be at work, home, or a similarly private location. At scale, this solution can be used to monitor traffic patterns through multiple stores or through an entire defined geographic area, with individual traces identified only by hashed ID consistent with the details shared in the '244 application and with location accuracy controlled by EDBR to protect customer privacy. Alternately, the path of individual devices through this area can be sampled or historically researched based on secure sharing of the hashedID. This would involve the use of two distinct hash keys: a “reference hash” known to both the external researcher and the carrier, and “carrier hash” known only to the carrier. The reference hash would be used only to confirm a customer of interest (with both parties deriving the hash independently), while the second carrier hash is used to securely share handset data as with the femtocell case. As previously disclosed, coincident video profiles would be required to create actual marketing personas based on these presence events.

In another aspect, the Face ID database can serve as a valuable source of operational data, including estimating total traffic through a store, dwell time per customer, and approximate quadrant most frequented by the customer during their visit. Effectiveness of marketing campaigns can be measured in part by the impact on foot traffic into the store and net increase in dwell time.

In another aspect, WiFi detections can be used to play a similar role as LTE femto cells to provide detection events. WiFi detections, however will tend to be less consistent and may involve the use of anonymized MAC addresses so will generally result in “noisy” personas. However these personas can still contribute significant economic value in the context of this overall persona-based machine vision solution.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A system comprising:
one or more video cameras for capturing image data;
one or more sensors for capturing wireless device metadata;
one or more computers comprising one or more processors and one or more storage locations, the one or more processors configured to execute software instructions to:
process the image data captured by the one or more video cameras using one or more neural networks to identify people within the image data and traits of the identified people;
generate a feature vector representing a person;
generate a persona for the person using the feature vector and based on identification information provided by the one or more sensors for capturing wireless device metadata.

2. The system of claim 1, wherein the processor generates the persona further based on machine vision demographics captured in the image data and observed activities of the person captured in the image data.

3. The system of claim 1, further comprising the step of refining the persona over time based detecting wireless device metadata of the person at multiple times

4. A method, comprising:
a) obtaining demographic features of a person using machine vision;
b) building a feature vector based on the demographic features; and
c) obtaining mapping information for the person from wireless device metadata, the mapping information mapping a wireless device to the feature vector.

5. The method of claim 4, wherein the wireless device metadata is a 4G or 5G signaling event.

6. The method of claim 4, wherein the wireless device metadata is wi-fi signaling event.

7. The method of claim 4, wherein the wireless devices metadata is a 4G or 5G macro cell with supplemental location reporting data to further localize the wireless device to establish its likely proximity to the covered area.

8. The method of claim 4, where the cellular metadata is hashed to prevent disclosure of actual parameters such as the phone number.

9. The method of claim 4, where the association of Device ID to Face ID is strong enough to create a combined profile, which could also be enriched with information such as loyalty account information.

10. The method of claim 7 where the level of resolution of supplemental location reporting is dynamically adjusted to such that location data cannot be uniquely attributed to any specific commercial user outside the context of this solution.

11. The method of claim 7 where one or a plurality of macro cells can provide aggregate traffic reporting as well as single-visitor profiles but with visitors only identified by hashed ID and location reported at a variable level of resolution such that attribution to a single user is not possible to a high degree of confidence.
